(19) United States
(12) Patent Application Publication
(10) Pub. No.: US 2010/0124403 A1
(43) Pub. Date: May 20, 2010

(54) Automatic correction of audio/video synchronization

(76) Inventor: Christopher Thornburg, Gilbert, AZ (US)

Correspondence Address: TROP, PRUNER & HU, P.C., 1616 S. VOSS RD., SUITE 750, HOUSTON, TX, 77057-2631, US

(21) Appl. No.: 12/313,155

(22) Filed: Nov. 18, 2008

(51) Int. Cl. H04N 5/95

(52) U.S. Cl. 386/66; 386/E05.037

(57) ABSTRACT

A media playback device may experience lack of video and audio synchronization due to subsequent processing by another device. For example, an audio/video receiver may be coupled to a television. The television may implement additional video processing which causes audio issued from the receiver to be out of synchronization with the video produced by the television. A detection unit may detect light produced by the television and a sound produced by a speaker based on signals that initially were synchronized. The detection unit may determine the difference between the times when the light and the sound are actually perceived. This time difference may then be used to reduce or increase a delay to synchronize the video and audio.

### BACKGROUND

This relates to media systems which play audio and video.

A variety of consumer electronic devices play both audio and video. Examples of such devices include set-top boxes, DVD players, and audio/video receivers. In many cases, relatively elaborate systems may be used to play audio and video. For example, a display in the form of a television, may be coupled to an audio/video receiver which, in turn, may be coupled to DVD players, set-top boxes, satellite receivers, and the like. As a result of processing by these various devices, the audio and video may appear to be out of synchronization to the end user.

### BRIEF DESCRIPTION OF THE DRAWINGS

FIG. 1 is a system depiction for one embodiment;

FIG. 2 is a flow chart for one embodiment; and

FIG. 3 is an audio and video time line for one embodiment.

### DETAILED DESCRIPTION

In accordance with some embodiments, an audio/video system may generate synchronized signals to flash a light on a display and to produce a sound. The sound and the light may be detected and the system determines whether they were issued in synchronization. If not, the circuit that produced the synchronized signals may have an adjustable delay to synchronize audio and video signals based on the time difference between the time when the sound and the light were actually detected.

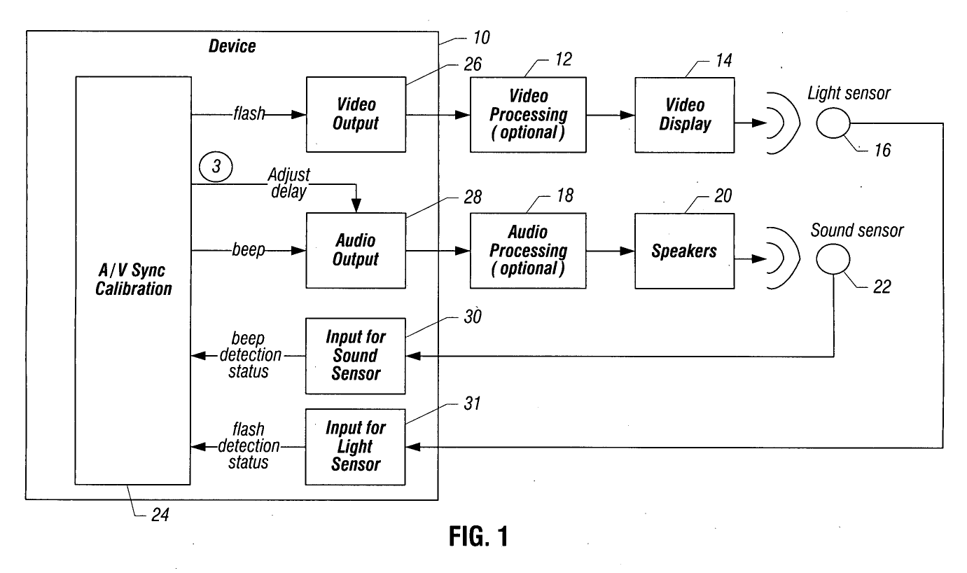

Referring to FIG. 1, in accordance with some embodiments of the present invention, a media playing device 10, such as a DVD player, a satellite receiver, a set-top box, or an audio/video receiver may be coupled through video processing devices 12 to a video display 14. Video processing devices 12 may be a variety of media processing or playback devices. The audio processing devices 18 may be coupled to speakers 20.

For example, an audio/video receiver, implementing the device 10, may be coupled to a television that functions both as the video processing device 12 and the display 14. In such case, audio may be output directly from the audio/video receiver, while video is further processed by the television. Thus, audio and video signals that were synchronized in the audio/video receiver may no longer be synchronized after separate processing of the video by the television. Because of the intervening processing by video processing devices 12 or audio processing devices 12, originally synchronized audio and video may no longer be synchronized.

Similarly, the audio output from the device 10 may be subject to subsequent audio processing. As an example, an audio source from a satellite receiver, implementing the device 10, may be further processed by an audio/video receiver, implementing the audio processing devices 18.

The device 10 may include an audio/video synchronization calibration circuit 24, coupled to video output 26 and audio output 28. It may provide a signal that ultimately produces a timed light flash to a video output 26. The flash is synchronized with a signal that ultimately produces a sound on speakers 20. In one example, the video may be a series of black frames, followed by a white frame, followed by a series of black frames. The audio may be a sound such as a beep. Thus, absent subsequent processing, the sound and light would occur at the same time. But because of the intervening video and/or audio processing device 12 and/or 18, audio/video synchronization may be disrupted.

The time when the light flash occurs may be detected by a light sensor 16 and, similarly, the time when the sound is produced may be detected by a sound sensor 22. As one example, the light sensor may be a light sensitive diode. The sound sensor 22 may be a microphone. The output from the light sensor and the sound sensor may be provided back to the device 10. Specifically, an input 30 receives a sound input signal from a sound sensor 22 and an input 31 receives a light input signal from the light sensor 16.

A beep detection status is outputted from the input 30 and a flash detection status is outputted from the input 31. The calibration circuit 24 then compares a time when the sound (e.g. a beep) actually occurred and the time when the light flash actually occurred and determines a time difference between the sound and light generation. This time difference may then be correlated to a delay adjustment provided at 3. The delay adjustment may be done by determining the time difference and using a lookup table to get a value to adjust the timing of the audio output. Alternatively, the timing of the video output can be adjusted instead, in another embodiment. In some cases, it may be desirable to retest the synchronization to be sure that it is correct after such an adjustment.

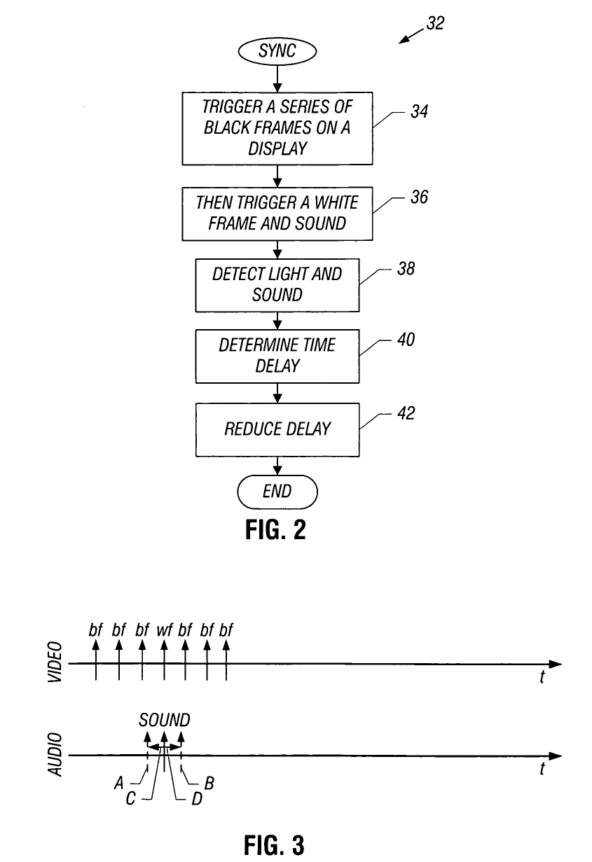

Referring to FIG. 2, in some embodiments, a series of black frames may be triggered on the display, as indicated in block 34. Then, a white frame and sound may be triggered at the same time, as indicated in block 36. The light and sound are detected, as indicated in block 38.

A time delay between the actual light and sound generation is then determined in block 40. Based on that time delay, an adjustment is determined, for example, using a lookup table at block 42. The adjustment may then be provided to the device 10 which outputs the sound or light information to delay one or the other of the audio or video signals to compensate for the subsequent audio and/or video processing and to create better audio and video synchronization.

Referring to FIG. 3, the video may be a series of black frames (BF). In one embodiment, three black frames may be followed by a white frame (WF), followed by three black frames. The system attempts to produce a sound at the same time as the white frame is produced, as indicated by the timeline marked “audio.” The sound should be produced at the time indicated by the solid arrow. But the sound may be produced early, as indicated by the dotted line arrow A or late, as indicated by the dotted line arrow B. Thus, a time difference C or D may be measured, which is the difference between the time when the sound should have been produced and the time when the sound was actually detected. This time difference may then be used to determine an appropriate delay. For example, in the case of the sound being produced early, as indicated at A, a delay may be provided for sound signals and, in the case of the sound being produced late, as indicated in B, a delay may be reduced to cause the sound to be produced earlier.

In some embodiments, the sequence depicted in FIG. 2 may be implemented in hardware. In other embodiments, it may be implemented in software, executed by the calibration circuit 24, for example. In some embodiments, the calibration circuit 24 may include a controller or microprocessor. The sequence depicted in FIG. 2 may be stored in a computer readable medium, such as a semiconductor memory, which, in one embodiment, may be part of the calibration circuit 24. In a software embodiment, the sequence depicted in FIG. 2 may be represented by a series of instructions which may be stored in such a computer readable medium.

The detection of the time differences may be done in a variety of conventional fashions. For example, a count may be initiated when the video and audio outputs are triggered. The time when the light and sound is detected may be marked or the count may be stopped. The marked times may be developed by timers that count up or down from the triggering of the video and audio information until such time as the light and sound information is detected. Since the timers started at the same time, their values may be differenced in order to determine the difference in time between the occurrence of the light and sound indications.

This time difference information may then be used in a variety of different ways. For example, a calculation may be done to determine the amount of time delay that would be appropriate to zero out the time difference. Alternatively, a lookup table may be used to correlate the time difference between the time when sound and light are detected and the amount of delay that needs to be added to a circuit, which delays at least one of the video or audio outputs. Those skilled in the art will appreciate a variety of other techniques to accomplish these same goals.

The processing techniques described herein may be implemented in various hardware architectures. For example, the functionality may be integrated within a chipset. Alternatively, a discrete video processor may be used. As still another embodiment, the functions may be implemented by a general purpose processor, including a multicore processor. For example, a video processor integrated circuit may implement the calibration circuit 24, video output 26, audio output 28, and inputs 30 and 31. Then, the wiring and sensors may be supplied by the manufacturer of a media player that includes the video processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. An apparatus comprising:
a synchronization device to issue synchronized signals to issue light and sound;
a detection unit to detect a time when the light is displayed and a time when the sound is generated as a result of said signal; and
a correction circuit to reduce the time difference between the light display and the sound generation.

2. The apparatus of claim 1 wherein said apparatus is an audio/video receiver.

3. The apparatus of claim 2 wherein said apparatus is a video processor integrated circuit.

4. The apparatus of claim 3 wherein said correction circuit to provide a delay between video and audio signals based on the time when said detection unit detected that the light was displayed and the sound was generated.

5. The apparatus of claim 1, said synchronization device to issue a signal to produce a light display including a series of black frames, followed by a light frame, followed by a series of black frames.

6. A method comprising:
generating a signal to produce a light and sound in synchronization;
determining a time difference between the generation of the light and the sound; and
using said time difference to automatically correct synchronization between video and audio generation.

7. The method of claim 6 including generating a signal to produce light and sound in synchronization from an audio/video receiver.

8. The method of claim 6 including determining a time difference in said audio/video receiver.

9. The method of claim 7 including determining said time difference in a video processing integrated circuit.

10. The method of claim 6 wherein using said time difference includes changing the synchronization between audio and video signals so that after subsequent processing, the audio and video signals will be in synchronization.

11. The method of claim 6 wherein using said time difference to automatically correct video synchronization includes delaying one of said audio and video.

12. The method of claim 6 including causing audio and video signals produced by an audio/video receiver to be out of synchronization so that after subsequent processing of video signals by a television, said audio and video signals will be substantially synchronized.
